(19) United States
(12) Patent Application Publication
(10) Pub. No.: US 2025/0315357 A1
(43) Pub. Date: Oct. 9, 2025

(54) IDENTIFICATION OF APPLICATION UNINSTALLATION AND REINSTALLATION

(71) Applicant: Beijing Zitiao Network Technology Co., Ltd., Beijing (CN)

(72) Inventors: Zeqing Xie, Beijing (CN); Yu Liu, Beijing (CN)

(21) Appl. No.: 19/170,031

(22) Filed: Apr. 3, 2025

(30) Foreign Application Priority Data
Apr. 7, 2024 (CN) 202410411693.7

(51) Int. Cl. G06F 11/30; G06F 11/32

(52) U.S. Cl. CPC G06F 11/3051; G06F 11/324

(57) ABSTRACT

According to embodiments of the disclosure, a method, an apparatus, a device, a medium and a product for identifying uninstallation and reinstallation are provided. In the method, in response to detecting an initial start request for a target application installed on a terminal device, a network request is initiated to a server device, the network request being configured to request for determining whether the target application is an uninstalled-reinstalled application or a non-uninstalled-reinstalled application on the terminal device; in response to detecting, during a start process, that a first function in a function chain of the application is to be presented, a display state of the first function is determined at least based on a response result for the network request; and the first function of the target application is presented in the terminal device based on the determined display state of the first function.

### CROSS-REFERENCE

The present application claims priority to Chinese Patent Application No. 202410411693.7, filed on Apr. 7, 2024, and entitled “METHOD, APPARATUS, DEVICE, MEDIUM AND PRODUCT FOR IDENTIFYING UNINSTALLATION AND REINSTALLATION”, the disclosure of which is incorporated herein by reference in its entirety.

### FIELD

Example embodiments of the present disclosure generally relate to the field of computers, and more particularly, to identification of application uninstallation and reinstallation.

### BACKGROUND

With the development of Internet technologies, the demand for installation and uninstallation services for various types of applications are increasing. Meanwhile, people may also reinstall applications, that they have previously installed and uninstalled afterwards, based on their needs at different times.

Therefore, for the applications that have been reinstalled after uninstallation, it is necessary to provide users with a quick and convenient experience at their first use.

### SUMMARY

In a first aspect of the present disclosure, a method for identifying application uninstallation and reinstallation is provided. The method comprises: in response to detecting an initial start request for a target application installed on a terminal device, initiating a network request to a server device, the network request being configured to request for determining whether the target application is an uninstalled-reinstalled application or a non-uninstalled-reinstalled application on the terminal device; in response to detecting, during a start process, that a first function in a function chain of the application is to be presented, determining a display state of the first function at least based on a response result for the network request, the function chain comprising at least one function to be presented sequentially in the application, a display state of a function comprising a first display state for the uninstalled-reinstalled application or a second display state for the non-uninstalled-reinstalled application; and presenting the first function of the target application in the terminal device based on the determined display state of the first function.

In a second aspect of the present disclosure, an apparatus for identifying application uninstallation and reinstallation is provided. The apparatus comprises: a network request initiating module configured to in response to detecting an initial start request for a target application installed on a terminal device, initiate a network request to a server device, the network request being configured to request for determining whether the target application is an uninstalled-reinstalled application or a non-uninstalled-reinstalled application on the terminal device; a display state determination module configured to in response to detect, during a start process, that a first function in a function chain of the target application is to be presented, determine a display state of the first function at least based on a response result for the network request, the function chain comprising at least one function to be presented sequentially in the target application, a display state of a function comprising a first display state for the uninstalled-reinstalled application or a second display state for the non-uninstalled-reinstalled application; and a function presenting module configured to present the first function of the target application in the terminal device based on the determined display state of the first function.

In a third aspect of the present disclosure, an electronic device is provided. The device comprising at least one processing unit; and at least one memory coupled to the at least one processing unit and storing instructions for execution by the at least one processing unit that, when executed by the at least one processing unit, cause the device to perform the method of the first aspect.

In a fourth aspect of the present disclosure, a computer readable storage medium is provided. The computer readable storage medium stores a computer program, and the computer program is executable by a processor to perform the method of the first aspect.

In a fifth aspect of the disclosure, a computer program product is provided. The computer program product is tangibly stored in a computer storage medium and comprises computer-executable instructions that, when executed by a device, cause the device to perform the method of the first aspect.

It should be understood that the content described in this Summary section is not intended to limit the key features or important features of the embodiments of the disclosure, nor is it intended to limit the scope of the disclosure. Other features of the disclosure will become readily understood from the following description.

### BRIEF DESCRIPTION OF THE DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates a flow chart of a conventional process for identifying application uninstallation and reinstallation;

FIG. 3 illustrates a flow chart of a process for identifying application uninstallation and reinstallation according to some embodiments of the present disclosure;

FIG. 4 illustrates a flow chart of a process for identifying application uninstallation and reinstallation according to some embodiments of the present disclosure;

FIG. 5 illustrates a block diagram of an apparatus for identifying application uninstallation and reinstallation according to some embodiments of the present disclosure; and

FIG. 6 illustrates a block diagram of an electronic device capable of implementing one or more embodiments of the present disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms and should not be construed as limited to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performing one step does not imply that this step is performed immediately after “A”, but may include one or more intermediate steps.

It may be understood that the data involved in the technical solution (including but not limited to the data itself, the obtaining or using of the data) should follow the requirements of the corresponding laws and regulations and related rules.

As used herein, the term “model” may learn associations between corresponding inputs and outputs from training data, such that after training is complete, a corresponding output may be generated for a given input. The generation of the model may be based on a machine learning technique. Deep learning is a machine learning algorithm that processes inputs and provides corresponding outputs by using a multi-layer processing unit. The “model” may also be referred to herein as “machine learning model”, “machine learning network”, or “network”. These terms are used interchangeably herein. A model may further include various types of processing units or networks.

It may be understood that before using the technical solutions disclosed in the embodiments of the disclosure, the user should be informed of the types, use ranges, usage scenario, and the like of the personal information related to the present disclosure in an appropriate manner according to relevant laws and regulations and the authorization of the user may be obtained.

For example, in response to receiving an active request from a user, prompt information is sent to the user to explicitly prompt the user that the requested operations to be performed would require acquisition and use of personal information of the user, such that the user may autonomously select whether to provide personal information to software or hardware such as an electronic device, an application, a server, or a storage medium that performs the operations of the technical solution of the disclosure, according to the prompt information.

As an optional but non-limiting implementation, in response to receiving an active request from a user, a manner of sending prompt information to the user may be, for example, a pop-up window, and the pop-up window may present the prompt information in a text manner. In addition, the pop-up window may further carry a selection control for the user to select “agree” or “disagree” to provide personal information to the electronic device.

It may be understood that the foregoing process of notifying and acquiring user authorization is merely illustrative, and does not constitute a limitation on the implementations of the disclosure, and other manners that meet related laws and regulations may also be applied to the implementations of the disclosure.

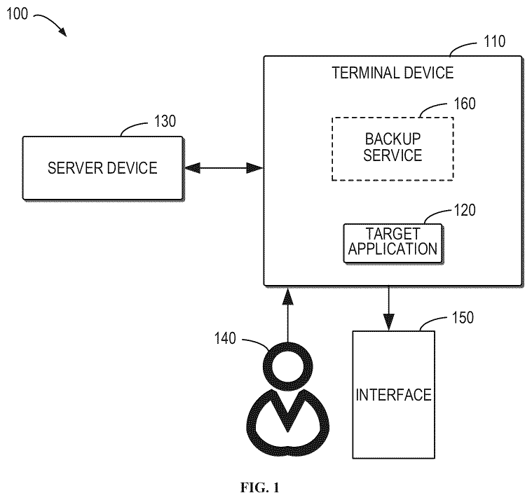

FIG. 1 illustrates a schematic diagram of an example environment 100 in which embodiments of the present disclosure can be implemented. As shown in FIG. 1, the example environment 100 may include a terminal device 110.

In this example environment 100, a target application 120 is installed in a terminal device 110. In some embodiments, the target application 120 may be a reinstalled application after being uninstalled from the terminal device 110 via a user 140. It should be understood that the number of times of uninstallation and reinstallation is not limited. For example, the target application 120 may be reinstalled a third time after uninstalling the target application 120 twice.

In some embodiments, a user 140 may interact with a target application 120 via a terminal device 110 and/or an attached device of a terminal device 110. In some embodiments, the user 140 may install and/or uninstall the target application 120 via other applications on the terminal device 110. In other embodiments, the user 140 may install and/or uninstall the target application 120 via a system configured in the terminal device 110. In some embodiments, the user 140 may install and/or uninstall the target application 120 via an attached device of the terminal device 110.

In some embodiments, for an uninstalled-reinstalled and/or a non-uninstalled-reinstalled target application 120, an interface 150 may be presented when the user 140 first starts the target application 120. In some embodiments, the interface 150 may display one or more functions of the target application 120, for example a function of the user 140 registering an account and logging in to an account, a function of providing the user 140 with instructions for use of the target application 120, etc. The functionality herein may be any suitable type of functionality supporting the user 140 to interact with the target application 120 via the interface 150.

In some embodiments, the terminal device 110 communicates with a service end device 130 to enable provision of an uninstalled-reinstalled service for the target application 120. In some embodiments, a backup service 160 may be included in the terminal device 110. Through the backup service 160, provision of an uninstalled-reinstalled service for the target application 120 may also be enabled.

In some embodiments, the terminal device 110 may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.).

The server device 130 may be an independent physical server, may also be a server cluster or a distributed system formed by a plurality of physical servers, and it may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 130 may include, for example, a computing system/server, such as a mainframe, an edge computing node, a computing device in a cloud environment, etc.

It should be understood that the structures and functions of the various elements in environment 100 are described for exemplary purposes only and do not imply any limitation to the scope of the disclosure.

As mentioned briefly above, for the uninstalled-reinstalled application, it is necessary to provide users with a quick and convenient experience at their first use. However, this effect is difficult to achieve in many conventional approaches for identifying application uninstallation and reinstallation.

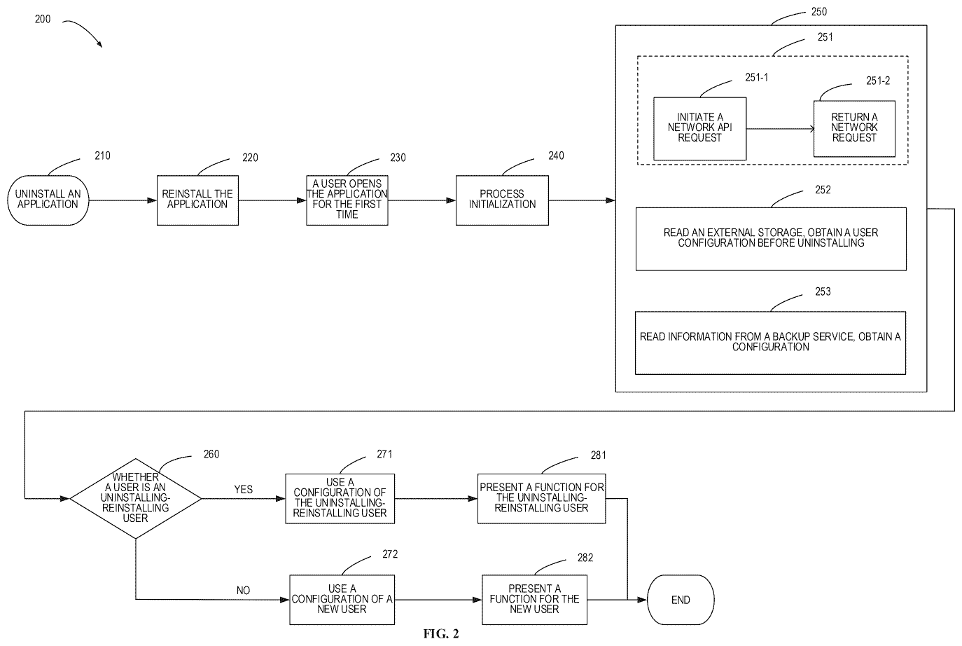

FIG. 2 illustrates a flow chart of a conventional process 200 for identifying application uninstallation and reinstallation. As shown in FIG. 2, for the process 200, after uninstalling an application (210), a user reinstalls the application (220), then when the user opens the application for the first time (230), the application performs process initialization (240). Next, in a conventional approach to identify application uninstallation and reinstallation, identification may be performed in any of the three approaches in approach 250, and then whether the user is an uninstalling-reinstalling user (260) is determined. In particular, a network-based approach 251, an external-storage-based approach 252, or a backup-service-ability-based approach 253 may be employed. With regard to an approach 251, when an application starts for the first time, the application initiates a network API (Application Programming Interface) request to a server (251-1), and uploads id (identification) data. The server returns a corresponding determination result and storage information to a client end where the application is located (251-2). With regard to an approach 252, relevant configuration data is written into an external storage before uninstalling an application. When a user reinstalls the App, the external storage is directly read to determine whether a user is an uninstalling-reinstalling user. With regard to an approach 253, a backup service ability provided by a manufacturer or a service provider is used. When a user reinstalls an uninstalled application, a configuration is directly read from a native backup service to determine whether a user is an uninstalling-reinstalling user. Based on the determination of any of the three approaches, if it is determined that the user is an uninstalling-reinstalling user, a relevant configuration matching the uninstalling-reinstalling user is used (271), and a function for the uninstalling-reinstalling user is presented (281). If it is determined that the user is not an uninstalling-reinstalling user, a relevant configuration matching a new user is used (272), and a function for the new user is presented (282).

In the above manner, for the approach 251, it is necessary to rely on the network, and the request time of the network is long and unstable, which will affect the function presentation upon the first start-up. For the approach 252, it is necessary to apply for an external storage permission. Otherwise, the approach 252 will not be effective on a terminal device installed with some configuration systems. And for other configuration systems, it is necessary to apply for a higher level permission to take effect. For the approach 253, it is necessary to rely on the backup service ability of the vendor, thus the coverage is limited.

Therefore, an application uninstallation and reinstallation may be determined and a corresponding function may be presented without using extra permission when an uninstalling-reinstalling user reinstalls an application and starts the application for the first time.

According to embodiments of the present disclosure, an improved scheme for identifying application uninstallation and reinstallation is provided. According to the scheme of the embodiments of the present disclosure, in response to detecting an initial start request for a target application installed on a terminal device, a network request to a server device is initiated, the network request is configured to request for determining whether the target application is an uninstalled-reinstalled application or a non-uninstalled-reinstalled application on the terminal device. Furthermore, in response to detecting, during a start process, that a first function in a function chain of the application is to be presented, a display state of the first function at least based on a response result for the network request is determined, the function chain comprises at least one function to be presented sequentially in the application, a display state of a function comprises a first display state for the uninstalled-reinstalled application or a second display state for the non-uninstalled-reinstalled application. Accordingly, the first function of the target application in the terminal device is presented based on the determined display state of the first function. Thus, in this manner, when identifying uninstallation and reinstallation for the target application, the stability and the coverage are strong, and no additional permission needs to be used, so that the required function can be quickly and conveniently presented to the user.

Some example embodiments of the present disclosure will be described below with continued reference to the accompanying drawings.

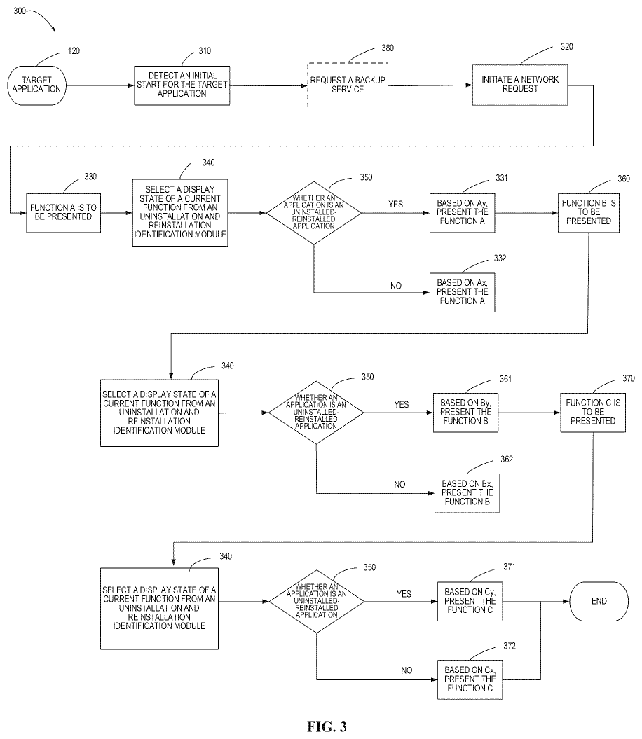

FIG. 3 illustrates a flow chart of a process 300 for identifying application uninstallation and reinstallation according to some embodiments of the present disclosure. For ease of discussion, the embodiments will be described with reference to the environment 100 of FIG. 1. The embodiments may be implemented in the terminal device 110 of FIG. 1.

As illustrated in FIG. 3, for a target application 120 already installed on the terminal device 110, the terminal device 110 may detect an initial start request for the target application 120 (310). In some embodiments, such a request may include an initial start request that is initiated based on an appropriate operation by the user 140. For example, the initial start request may include a request initiated by the user 140 through a first clicking on the target application 120. Upon detecting the initial start request (310), the terminal device 110 may initiate a network request to the server device 130. In some embodiments, the network request may be configured to request for determining whether the target application 120 is an uninstalled-reinstalled application or a non-uninstalled-reinstalled application on the terminal device 110. In some embodiments, the non-uninstalled-reinstalled applications may at least include a new application installed in the terminal device 110 for the first time. In some embodiments, the network request may include, but is not limited to, a network API request.

Further, during an initial start process of the target application 120, the terminal device 110 may detect that a first function in a function chain of the target application 120 is to be presented. In some embodiments, the function chains may include a demand chain, and the functions may also include demands. Functions may be, for example, registration, login, etc. with regard to an account of a user, and may also be use instructions, use guidance procedures, etc. regarding the target application 120. In some embodiments, a function chain may include a plurality of functions that are independent of each other. Taking a function about the use guidance procedure of the target application 120 as an example, although the guidance procedure includes a plurality of different demands, the demands are closely related, that is, are not independent of each other, and therefore, these demands may form a function.

Taking FIG. 3 as an example, it is assumed that a plurality of functions in the function chain may include a function A, a function B, and a function C which are independent of each other. In this case, the terminal device 110 may detect that a function A (which may be a first function) in the function chain is to be presented (330), may also detect that a function B (which may also be a first function) in the function chain is to be presented (360), and may further detect that a function C (which may also be a first function) in the function chain is to be presented (370). Upon detecting that a first function (e. g., a function A, a function B, or a function C) in the function chain is to be presented, the terminal device 110 may determine a display state of the first function at least based on a response result for the network request. The response result for the network request includes but is not limited to the returning time of the returned data of the network request. In some embodiments, the function chain may include at least one function to be presented sequentially in the target application 120. For example, a function A, a function B, and a function C may be three functions to be presented sequentially. It should be understood that the example of FIG. 3 is only for the purpose of explanation and illustration, and in practical, for two cases of uninstallation-reinstallation and non-uninstallation-reinstallation, more or fewer functions independent of each other may exist in an application and need to be presented in different display states.

In some embodiments, the display states of each function include a first display state for an uninstalled-reinstalled application and a second display state for a non-uninstalled-reinstalled application. In some embodiments, an uninstallation and reinstallation identification module taking a function as a dimension may be set in the terminal device 110, and may store a first display state (for example, x) and a second display state (for example, y) of a plurality of functions in a function chain. Specifically, upon detecting that a first function (e. g., a function A, a function B, or a function C) in the function chain is to be presented (330, 360, 370), the display states of the current function may be selected from the uninstallation and reinstallation identification module (340), and then whether the target application 120 is an uninstalled-reinstalled application may be determined based on a response result of the network request (350). In some embodiments, determining whether the target application 120 is an uninstalled-reinstalled application may include determining whether the user 140 of the target application 120 is an uninstalling-reinstalling user.

Further, for a certain first function, if the target application 120 of the first function is an uninstalled-reinstalled application, a display state of the function is a first display state. If the target application 120 of the function is a non-uninstalled-reinstalled application, the display state of the function is a second display state. If determining whether the target application 120 is an uninstalled-reinstalled application includes determining whether the user 140 of the target application 120 is an uninstalling-reinstalling user, the display state of the function may be a first display state when the user 140 of the target application 120 is an uninstalling-reinstalling user. If the user 140 of the target application 120 is a non-uninstalling-reinstalling user, i.e., a new user, the display state of the function may be a second display state.

Still taking a function A, a function B, and a function C as examples, if the target application 120 is an uninstalled-reinstalled application, the display state of the function A may be, for example, a first display state Ay, the display state of the function B may be, for example, a first display state By, and the display state of the function C may be, for example, a first display state Cy. If the target application 120 is a non-uninstalled-reinstalled application, the display state of the function A may be, for example, a second display state Ax, the display state of the function B may be, for example, a second display state Bx, and the display state of the function C may be, for example, a second display state Cx.

Further, the terminal device 110 may present a first function of the target application 120 in the terminal device 110 based on the determined display state of the first function. That is, if the target application 120 is an uninstalled-reinstalled application, the first function would be presented on the target application 120 based on the first display state. If the target application 120 is a non-uninstalled-reinstalled application, the first function would be presented on the target application 120 based on the second display state. Still taking FIG. 3 as an example, for the function A, after it is determined whether the target application 120 is an uninstalled-reinstalled application (350), if the target application 120 is an uninstalled-reinstalled application, the function A is presented in the terminal device 110 according to the first display state Ay (331). If the target application 120 is a non-uninstalled-reinstalled application, the function A is presented in the terminal device 110 according to the second display state Ax (332). For the function B, after it is determined whether the target application 120 is an uninstalled-reinstalled application (350), if the target application 120 is an uninstalled-reinstalled application, the function B is presented in the terminal device 110 according to the first display state By (361). If the target application 120 is a non-uninstalled-reinstalled application, the function B is presented in the terminal device 110 according to the second display state Bx (362). For the function C, after it is determined whether the target application 120 is an uninstalled-reinstalled application (350), if the target application 120 is an uninstalled-reinstalled application, the function C is presented in the terminal device 110 according to the first display state Cy (371). If the target application 120 is a non-uninstalled-reinstalled application, the function C is presented in the terminal device 110 according to the second display state Cx (372).

Thus, a function chain is segmented by granularity according to independence, and then relevant logic determination for identifying application uninstallation and reinstallation is performed, thereby avoiding the influence of delayed response to a network request, and effectively improving identification efficiency and identification stability of the application uninstallation and reinstallation.

In some embodiments, upon determining the display state of the first function based on the response results for the network request, if a first response message for the network request is received when it is detected that the first function is to be presented and the first response message includes configuration information corresponding to the first function when the target application 120 is the uninstalled-reinstalled application, then the terminal device 110 may determine that the display state of the first function is the first display state for the uninstalled-reinstalled application. If the first response message for the network request is not received when it is detected that the first function is to be presented or the first response request does not include configuration information corresponding to the first function when the target application 120 is the uninstalled-reinstalled application, the terminal device 110 may determine the display state of the first function is the second display state for the non-uninstalled-reinstalled application. Still taking FIG. 3 as an example, assuming that the first function is a function B, if a first response message for the network request is received when it is detected that the function B is to be presented (360) and the first response message includes configuration information corresponding to the function B when the target application 120 is the uninstalled-reinstalled application, the terminal device 110 determines the display state of the function B is a first display state By for the uninstalled-reinstalled application. If a first response message for the network request is not received when it is detected that the function B is to be presented (360) or the first response message does not include configuration information corresponding to the function B when the target application 120 is the uninstalled-reinstalled application, for example, if the first response message only includes an indication of whether the function A corresponds to the uninstalled-reinstalled application, the terminal device 110 determines the display state of the function B is a second display state Bx for the non-uninstalled-reinstalled application.

In some embodiments, when presenting a first function of a target application 120 in a terminal device 110, if determining that a display state for the first function is a first display state for an uninstalled-reinstalled application, the terminal device 110 may present the first function of the target application 120 in the terminal device 110 based on the configuration information corresponding to the first function. In other words, the configuration information included in the first response message for the network request may further determine the display state of the first function. For example, if determining that the display state for the function B is a first display state By for the uninstalled-reinstalled application, the terminal device 110 presents the function B of the target application 120 in the terminal device 110 based on the configuration information corresponding to the function B.

Thus, the display state of the first function is further determined according to the configuration information corresponding to the first function in the response message for the network request, which can ensure the accuracy for identifying application uninstallation and reinstallation, and is more conducive to providing the user with efficient and convenient use experience.

In some embodiments, if a second function following a first function in the function chain of the target application 120 is detected to be presented during a start process, the terminal device 110 may determine the display state of the second function based at least on the response result for the network request. Accordingly, the terminal device 110 may present a second function of the target application 120 in the terminal device 110 based on the determined display state of the second function.

In some embodiments, if the response result for the network request includes the returning time of the returned data (i.e., the response message) of the network request, the terminal device 110 may determine the display state of the function chain according to the returning time. For example, the terminal device 110 may determine the display state of each function based on the order of the returning time of the returned data of the network request and the presentation time of each function in the function chain. In this case, the terminal device 110 may determine the display state corresponding to the first function and one or more functions following the first function as the first display state based on that the returning time is before the presentation time of the first function among the plurality of functions and after the presentation time of the previous function of the first function. Further, based on that the presentation time of the second function among the plurality of functions is before the returning time, the terminal device 110 may determine the display state corresponding to the second function and one or more functions prior to the second function as the second display state. Therefore, according to the returning time of the returned data of the network request, the display states of all the functions in the function chain may be determined at one time. This is equivalent to directly determining a corresponding display state for a non-presented function.

Continuing taking FIG. 3 as an example, if the returning time of the returned data of the network request is prior to the function B is to be presented (360), and after the function A is to be presented (330), then it may be determined that the function A needs to be presented based on a second display state Ax corresponding to the target application 120 being a non-uninstalled application, and the function B needs to be presented based on a first display state By corresponding to the target application 120 being an uninstalled application. The following function C may be presented directly based on a first display state Cy corresponding to the target application 120 being an uninstalled application. Thus, the display state of the function can be quickly determined based on the returning time of the response of the network request, thereby improving the user experience.

In other embodiments, the returned result of the network request may be segmented by the granularity of functions and returned in the order of granularity of each function. When a plurality of functions are sequentially to be presented in order, the display state of the current function may be determined according to the returned result of the network request, respectively. For example, when the function A is to be presented (330), the display state of the function A may be determined according to the returned result of the network request. When the function B is to be presented (360), the display state of the function B may be determined according to the returned result of the network request. When the function C is to be presented (370), the display state of the function C may be determined according to the returned result of the network request. Thus, the display state of each function at the time of presentation can be ensured, thereby cause the function presentation more stable.

In some embodiments, if an initial start request for the target application 120 is detected, the terminal device 110 may determine whether the terminal device 110 provides a backup service 160 for the target application 120 with the network request being initiated. If it is determined that the terminal device 110 provides the backup service 160 for the target application 120, the terminal device 110 may obtain configuration information associated with the target application 120 from the backup service 160, and based on the obtained configuration information, determine whether the target application 120 is the uninstalled-reinstalled application or the non-uninstalled-reinstalled application on the terminal device 110.

As illustrated in FIG. 3, after detecting the initial start of the target application 120 (310), the backup service 160 may be requested (380) and simultaneously the network request may be initiated (320). If the backup service 160 is successfully request, the terminal device 110 may obtain configuration information associated with the target application 120 from the backup service 160, and may directly determine, based on the configuration information, whether the target application 120 is the uninstalled-reinstalled application or the non-uninstalled-reinstalled application on the terminal device 110. Thus, by using backup service 160, identification of the uninstalled-reinstalled application can be speeded up.

In some embodiments, when determining the display state of the first function at least based on the response result for the network request, the terminal device 110 determines the display state of the first function based on the response result for the network request and further based on a determination that whether the target application 120 is the uninstalled-reinstalled application or the non-uninstalled-reinstalled application on the terminal device 110 based on the obtained configuration information. That is, the display state of the first function needs to be determined based on the response result for the network request and the configuration information obtained from the backup service 160. Thus, the backup service mode is introduced to determine the application uninstallation and reinstallation according to a network request-based mode. The stability for identifying uninstallation and reinstallation can be improved, and the time consumption can be reduced.

In some embodiments, when determining the display state of the first function based on a determination that whether the target application 120 is the uninstalled-reinstalled application or the non-uninstalled-reinstalled application on the terminal device 110 based on the obtained configuration information, if it is determined, based on the obtained configuration information, that the target application 120 is the uninstalled-reinstalled application on the terminal device 110, then the terminal device 110 may determine the display state of each function in the function chain as the first display state. If it is determined, based on the obtained configuration information, that the target application 120 is the non-uninstalled-reinstalled application on the terminal device 110, then the terminal device 110 may determine the display state of each function in the function chain is the second display state. That is, if it is determined, based on the backup service 160, that the target application 120 is the uninstalled-reinstalled application or is the non-uninstalled-reinstalled application, the display state of all functions in the function chain may be determined at one time.

As shown in FIG. 3, if the backup service 160 is requested successfully (380), and it is determined, based on the obtained configuration information, that the target application 120 is the uninstalled-reinstalled application, it may be determined at one time that the function A is presented based on the first display state Ay (331), the function B is presented based on the first display state By (361), and the function C is presented based on the first display state Cy (371). If the backup service 160 is requested successfully (380), and it is determined, based on the obtained configuration information, that the target application 120 is the non-uninstalled-reinstalled application, it may be determined at one time that the function A is presented based on the second display state Ax (332), the function B is presented based on the second display state Bx (362), and the function C is presented based on the second display state Cx (372). Thus, by using the backup service 160, presenting functions based on a display state is significantly speeded up.

In some embodiments, if it is determined that the terminal device 110 fails to provide the backup service for the target application 120, the terminal device 110 may determine the display state of the first function in accordance with the response result for the network request. That is, after the backup service 160 is failed to request, the terminal device 110 may determine the display state of the first function merely based on the response results for the network request. Thus, based on the way of backup services, in combination with the way of network requests, the application uninstallation and reinstallation is identified, and the coverage of identification can be improved.

Based on the process described above, the embodiments of the present disclosure can identification efficiency and identification stability of the application uninstallation and reinstallation, and improve the coverage of identification.

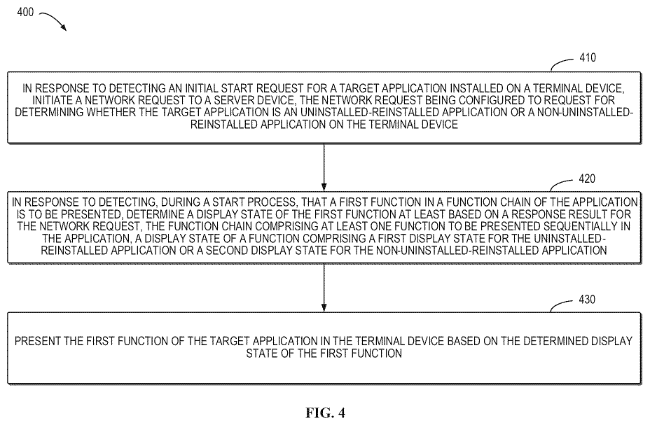

FIG. 4 illustrates a flow chart of a process 400 for identifying application uninstallation and reinstallation according to some embodiments of the present disclosure. The process 400 may be implemented at the terminal device 110. The process 400 is described below with reference to FIG. 1.

As shown in FIG. 4, at block 410, in response to detecting an initial start request for a target application 120 installed on a terminal device 110, the terminal device 110 initiates a network request to the server device 130. The network request is configured to request for determining whether the target application 120 is an uninstalled-reinstalled application or a non-uninstalled-reinstalled application on the terminal device 110.

At block 420, in response to detecting, during a start process, that a first function in a function chain of the target application 120 is to be presented, the terminal device 110 determines a display state of the first function at least based on a response result for the network request. The function chain comprises at least one function to be presented sequentially in the target application 120, and a display state of each function comprises a first display state for the uninstalled-reinstalled application and a second display state for the non-uninstalled-reinstalled application.

At block 430, the terminal device 110 presents the first function of the target application 120 in the terminal device 110 based on the determined display state of the first function.

In some embodiments, determining the display state of the first function based on the response result for the network request comprises: in response to receiving a first response message for the network request when detecting that the first function is to be presented and in response to the first response message comprising configuration information corresponding to the first function when the target application 120 is the uninstalled-reinstalled application, determining that the display state of the first function is the first display state for the uninstalled-reinstalled application; and in response to failing to receive the first response message for the network request when detecting that the first function is to be presented or in response to the first response message comprises no configuration information corresponding to the first function when the target application 120 is the uninstalled-reinstalled application, determining that the display state of the first function is the second display state for the non-uninstalled-reinstalled application.

In some embodiments, presenting the first function of the target application 120 in the terminal device 110 comprises: in response to determining that the display state of the first function is the first display state for the uninstalled-reinstalled application, presenting the first function of the target application 120 in the terminal device 110 based on configuration information corresponding to the first function.

In some embodiments, the process 400 further comprises: in response to detecting, during the start process, that a second function following the first function in the function chain of the target application 120 is to be presented, determining a display state of the second function based at least on the response result for the network request; and presenting the second function of the target application 120 in the terminal device 110 based on the determined display state of the second function.

In some embodiments, the process 400 further comprises: in response to detecting the initial start request for the target application 120, determining whether the terminal device 110 provides a backup service for the target application 120 with the network request being initiated; in response to determining that the terminal device 110 provides the backup service for the target application 120, obtaining configuration information associated with the target application 120 from the backup service; and determining whether the target application 120 is the uninstalled-reinstalled application or the non-uninstalled-reinstalled application on the terminal device 110 based on the obtained configuration information.

In some embodiments, determining the display state of the first function based at least on the response result for the network request comprises: determining the display state of the first function based on the response result for the network request and further based on a determination result of whether the target application 120 is the uninstalled-reinstalled application or the non-uninstalled-reinstalled application on the terminal device 110 based on the obtained configuration information.

In some embodiments, determining the display state of the first function based on a determination result of whether the target application 120 is the uninstalled-reinstalled application or the non-uninstalled-reinstalled application on the terminal device 110 based on the obtained configuration information comprises: in response to determining, based on the obtained configuration information, that the target application 120 is the uninstalled-reinstalled application on the terminal device 110, determining display states of respective functions in the function chain to be the first display state; and in response to determining, based on the obtained configuration information, that the target application 120 is the non-uninstalled-reinstalled application on the terminal device 110, determining display states of respective functions in the function chain to be the second display state.

In some embodiments, the process 400 further comprises: in response to determining that the terminal device 110 fails to provide the backup service for the target application 120, determining the display state of the first function based on the response result for the network request.

In some embodiments, the function chain comprises a plurality of functions that are independent of each other.

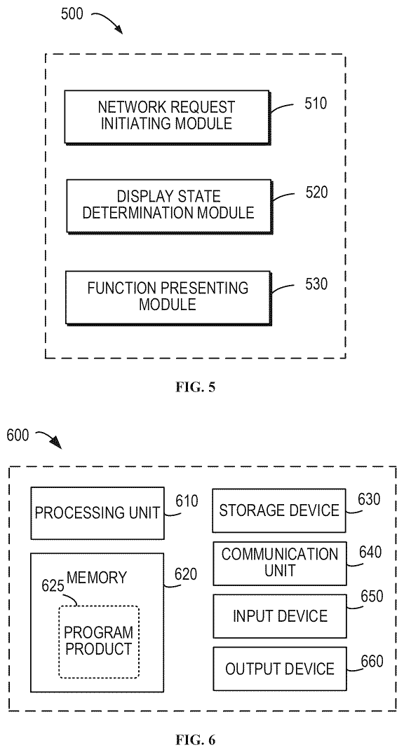

FIG. 5 illustrates a block diagram of an apparatus 500 for identifying application uninstallation and reinstallation according to some embodiments of the present disclosure. The apparatus 500 may be implemented as a terminal apparatus 110 or included in a terminal apparatus 110. The various modules/components of the apparatus 500 may be implemented by hardware, software, firmware, or any combination thereof.

As shown in FIG. 5, the apparatus 500 comprises a network request initiating module 510 configured to, in response to detecting an initial start request for a target application installed on a terminal device, initiate a network request to a server device, the network request being configured to request for determining whether the target application is an uninstalled-reinstalled application or a non-uninstalled-reinstalled application on the terminal device; a display state determination module 520 configured to in response to detect, during a start process, that a first function in a function chain of the target application is to be presented, determine a display state of the first function at least based on a response result for the network request, the function chain comprising at least one function to be presented sequentially in the target application, a display state of a function comprising a first display state for the uninstalled-reinstalled application or a second display state for the non-uninstalled-reinstalled application; and a function presenting module 530 configured to present the first function of the target application in the terminal device based on the determined display state of the first function.

In some embodiments, the display state determination module 520 is further configured for in response to receiving a first response message for the network request when detecting that the first function is to be presented and in response to the first response message comprising configuration information corresponding to the first function when the target application is the uninstalled-reinstalled application, determining that the display state of the first function is the first display state for the uninstalled-reinstalled application; and in response to failing to receive the first response message for the network request when detecting that the first function is to be presented or in response to the first response message comprises no configuration information corresponding to the first function when the target application is the uninstalled-reinstalled application, determining that the display state of the first function is the second display state for the non-uninstalled-reinstalled application.

In some embodiments, the function presenting module 530 is further configured for in response to determining that the display state of the first function is the first display state for the uninstalled-reinstalled application, presenting the first function of the target application in the terminal device based on the configuration information corresponding to the first function.

In some embodiments, the apparatus 500 further comprises a second function presentation module configured for in response to detecting, during the start process, that a second function following the first function in the function chain of the application is to be presented, determining a display state of the second function based at least on the response result for the network request; and presenting the second function of the target application in the terminal device based on the determined display state of the second function.

In some embodiments, the apparatus 500 further comprises an uninstalled-reinstalled application determination module configured for, in response to detecting the initial start request for the target application, determining whether the terminal device provides a backup service for the target application with the network request being initiated; in response to determining that the terminal device provides the backup service for the target application, obtaining configuration information associated with the target application from the backup service; and determining whether the target application is the uninstalled-reinstalled application or the non-uninstalled-reinstalled application on the terminal device based on the obtained configuration information.

In some embodiments, the display state determination module 520 is further configured for determining the display state of the first function based on the response result for the network request and further based on a determination result of whether the target application is the uninstalled-reinstalled application or the non-uninstalled-reinstalled application on the terminal device based on the obtained configuration information.

In some embodiments, the display state determination module 520 is further configured for, in response to determining, based on the obtained configuration information, that the target application is the uninstalled-reinstalled application on the terminal device, determining display states of respective functions in the function chain to be the first display state; and in response to determining, based on the obtained configuration information, that the target application is the non-uninstalled-reinstalled application on the terminal device, determining display states of respective functions in the function chain to be the second display state.

In some embodiments, the apparatus 500 further comprises a response module configured for, in response to determining that the terminal device fails to provide the backup service for the target application, determining the display state of the first function based on the response result for the network request.

In some embodiments, the function chain comprises a plurality of functions that are independent of each other.

The units and/or modules included in the apparatus 500 may be implemented in various forms, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 illustrates a block diagram of an electronic device 600 capable of implementing one or more embodiments of the present disclosure. It should be understood that the electronic device 600 shown in FIG. 6 is merely for example and should not constitute any limitation on the function and scope of the embodiments described herein. The electronic device 600 shown in FIG. 6 may be configured to implement the terminal device 110 of FIG. 1 or the apparatus 500 of FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

The electronic device 600 typically includes a plurality of computer storage media. Such media may be any available media accessible by the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data (for example, the training data for training) and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the disclosure.

The communications unit 640 implements communications with other electronic devices over a communications medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

What is claimed is:

1. A method for identifying application uninstallation and reinstallation, comprising:
in response to detecting an initial start request for a target application installed on a terminal device, initiating a network request to a server device, the network request being configured to request for determining whether the target application is an uninstalled-reinstalled application or a non-uninstalled-reinstalled application on the terminal device;
in response to detecting, during a start process, that a first function in a function chain of the application is to be presented, determining a display state of the first function at least based on a response result for the network request, the function chain comprising at least one function to be presented sequentially in the application, a display state of a function comprising a first display state for the uninstalled-reinstalled application or a second display state for the non-uninstalled-reinstalled application; and
presenting the first function of the target application in the terminal device based on the determined display state of the first function.

2. The method of claim 1, wherein determining the display state of the first function based on the response result for the network request comprises:
in response to receiving a first response message for the network request when detecting that the first function is to be presented and in response to the first response message comprising configuration information corresponding to the first function when the target application is the uninstalled-reinstalled application, determining that the display state of the first function is the first display state for the uninstalled-reinstalled application; and
in response to failing to receive the first response message for the network request when detecting that the first function is to be presented or in response to the first response message comprises no configuration information corresponding to the first function when the target application is the uninstalled-reinstalled application, determining that the display state of the first function is the second display state for the non-uninstalled-reinstalled application.

3. The method of claim 2, wherein presenting the first function of the target application in the terminal device comprises:
in response to determining that the display state of the first function is the first display state for the uninstalled-reinstalled application, presenting the first function of the target application in the terminal device based on the configuration information corresponding to the first function.

4. The method of claim 1, further comprising:
in response to detecting, during the start process, that a second function following the first function in the function chain of the application is to be presented, determining a display state of the second function based at least on the response result for the network request; and
presenting the second function of the target application in the terminal device based on the determined display state of the second function.

5. The method of claim 1, further comprising:
in response to detecting the initial start request for the target application, determining whether the terminal device provides a backup service for the target application with the network request being initiated;
in response to determining that the terminal device provides the backup service for the target application, obtaining configuration information associated with the target application from the backup service; and
determining whether the target application is the uninstalled-reinstalled application or the non-uninstalled-reinstalled application on the terminal device based on the obtained configuration information.

6. The method of claim 5, wherein determining the display state of the first function based at least on the response result for the network request comprises:
determining the display state of the first function based on the response result for the network request and further based on a determination result of whether the target application is the uninstalled-reinstalled application or the non-uninstalled-reinstalled application on the terminal device based on the obtained configuration information.

7. The method of claim 6, wherein determining the display state of the first function based on a determination result of whether the target application is the uninstalled-reinstalled application or the non-uninstalled-reinstalled application on the terminal device based on the obtained configuration information comprises:
in response to determining, based on the obtained configuration information, that the target application is the uninstalled-reinstalled application on the terminal device, determining display states of respective functions in the function chain to be the first display state; and
in response to determining, based on the obtained configuration information, that the target application is the non-uninstalled-reinstalled application on the terminal device, determining display states of respective functions in the function chain to be the second display state.

8. The method of claim 6, further comprising:
in response to determining that the terminal device fails to provide the backup service for the target application, determining the display state of the first function based on the response result for the network request.

9. The method of claim 1, wherein the function chain comprises a plurality of functions that are independent of each other.

10. An electronic device, comprising:
at least one processing unit; and
at least one memory coupled to the at least one processing unit and storing instructions for execution by the at least one processing unit that, when executed by the at least one processing unit, cause the electronic device to perform acts comprising:
in response to detecting an initial start request for a target application installed on a terminal device, initiating a network request to a server device, the network request being configured to request for determining whether the target application is an uninstalled-reinstalled application or a non-uninstalled-reinstalled application on the terminal device;
in response to detecting, during a start process, that a first function in a function chain of the application is to be presented, determining a display state of the first function at least based on a response result for the network request, the function chain comprising at least one function to be presented sequentially in the application, a display state of a function comprising a first display state for the uninstalled-reinstalled application or a second display state for the non-uninstalled-reinstalled application; and
presenting the first function of the target application in the terminal device based on the determined display state of the first function.

11. The electronic device of claim 10, wherein determining the display state of the first function based on the response result for the network request comprises:
in response to receiving a first response message for the network request when detecting that the first function is to be presented and in response to the first response message comprising configuration information corresponding to the first function when the target application is the uninstalled-reinstalled application, determining that the display state of the first function is the first display state for the uninstalled-reinstalled application; and
in response to failing to receive the first response message for the network request when detecting that the first function is to be presented or in response to the first response message comprises no configuration information corresponding to the first function when the target application is the uninstalled-reinstalled application, determining that the display state of the first function is the second display state for the non-uninstalled-reinstalled application.

12. The electronic device of claim 11, wherein presenting the first function of the target application in the terminal device comprises:
in response to determining that the display state of the first function is the first display state for the uninstalled-reinstalled application, presenting the first function of the target application in the terminal device based on the configuration information corresponding to the first function.

13. The electronic device of claim 10, further comprising:
in response to detecting, during the start process, that a second function following the first function in the function chain of the application is to be presented, determining a display state of the second function based at least on the response result for the network request; and
presenting the second function of the target application in the terminal device based on the determined display state of the second function.

14. The electronic device of claim 10, further comprising:
in response to detecting the initial start request for the target application, determining whether the terminal device provides a backup service for the target application with the network request being initiated;
in response to determining that the terminal device provides the backup service for the target application, obtaining configuration information associated with the target application from the backup service; and
determining whether the target application is the uninstalled-reinstalled application or the non-uninstalled-reinstalled application on the terminal device based on the obtained configuration information.

15. The electronic device of claim 14, wherein determining the display state of the first function based at least on the response result for the network request comprises:
determining the display state of the first function based on the response result for the network request and further based on a determination result of whether the target application is the uninstalled-reinstalled application or the non-uninstalled-reinstalled application on the terminal device based on the obtained configuration information.

16. The electronic device of claim 15, wherein determining the display state of the first function based on a determination result of whether the target application is the uninstalled-reinstalled application or the non-uninstalled-reinstalled application on the terminal device based on the obtained configuration information comprises:
in response to determining, based on the obtained configuration information, that the target application is the uninstalled-reinstalled application on the terminal device, determining display states of respective functions in the function chain to be the first display state; and
in response to determining, based on the obtained configuration information, that the target application is the non-uninstalled-reinstalled application on the terminal device, determining display states of respective functions in the function chain to be the second display state.

17. The electronic device of claim 15, further comprising:
in response to determining that the terminal device fails to provide the backup service for the target application, determining the display state of the first function based on the response result for the network request.

18. The electronic device of claim 10, wherein the function chain comprises a plurality of functions that are independent of each other.

19. A non-transitory computer readable storage medium having a computer program stored thereon, the computer program being executable by a processor to perform acts comprising:
in response to detecting an initial start request for a target application installed on a terminal device, initiating a network request to a server device, the network request being configured to request for determining whether the target application is an uninstalled-reinstalled application or a non-uninstalled-reinstalled application on the terminal device;
in response to detecting, during a start process, that a first function in a function chain of the application is to be presented, determining a display state of the first function at least based on a response result for the network request, the function chain comprising at least one function to be presented sequentially in the application, a display state of a function comprising a first display state for the uninstalled-reinstalled application or a second display state for the non-uninstalled-reinstalled application; and
presenting the first function of the target application in the terminal device based on the determined display state of the first function.

20. The non-transitory computer readable storage medium of claim 19, wherein determining the display state of the first function based on the response result for the network request comprises:
in response to receiving a first response message for the network request when detecting that the first function is to be presented and in response to the first response message comprising configuration information corresponding to the first function when the target application is the uninstalled-reinstalled application, determining that the display state of the first function is the first display state for the uninstalled-reinstalled application; and
in response to failing to receive the first response message for the network request when detecting that the first function is to be presented or in response to the first response message comprises no configuration information corresponding to the first function when the target application is the uninstalled-reinstalled application, determining that the display state of the first function is the second display state for the non-uninstalled-reinstalled application.
